(19) United States
(12) Patent Application Publication
(10) Pub. No.: US 2025/0068787 A1
(43) Pub. Date: Feb. 27, 2025

(54) SYSTEM, METHOD AND COMPUTER PROGRAM PRODUCT FOR CONSTRUCTION

(71) Applicant: Wall to Wall, LLC, Hayward, CA (US)

(72) Inventors: Hezi DEBBY, Tel Aviv (IL); Dvir Dor SPENSER, Tel Aviv (IL); Noam RONEN, Be'er Tuvia (IL)

(73) Assignee: Wall to Wall, LLC, Hayward, CA (US)

(21) Appl. No.: 18/724,596

(22) PCT Filed: Dec. 27, 2022
(86) PCT No.: PCT/IL2022/051391

§ 371 Date: Jun. 26, 2024

Related U.S. Application Data
(60) Provisional application No. 63/293,948, filed on Dec. 27, 2021.

(51) Int. Cl. G06F 30/18; G06F 30/13; G06F 111/16; G06F 111/20; G06F 113/14; G06F 113/16; G06F 119/18

(52) U.S. Cl. CPC G06F 30/18; G06F 30/13; G06F 2111/16; G06F 2111/20; G06F 2113/14; G06F 2113/16; G06F 2119/18

(57) ABSTRACT

A system, computer program product and method for architectural design, comprising determining walls with which each of plural MEP elements are respectively associated; and/or providing manufacturing instructions for factory-production of walls wherein each wall w is configured to accommodate at least a subset of, typically all of, the MEP elements associated with wall W.

### CROSS REFERENCE TO RELATED APPLICATIONS

This application is a U.S. National Stage application under 35 USC 371 of International Application No. PCT/IL2022/051391, filed Dec. 27, 2022, which claims the benefit and priority of U.S. Provisional Application No. 63/293,948, filed Dec. 27, 2021. The entire contents of each priority application are incorporated herein by reference.

### FIELD OF THE DISCLOSURE

The present invention relates generally to construction, and more particularly to pre-fabrication for construction.

### BACKGROUND OF THE DISCLOSURE

State-of-the-art Revit techniques including visualization are described e.g. here: https://forums.augi.com/showthread.php?121191-AutoCAD-Layer-Freeze-Revit file:///C:/Users/sudym/Downloads/Revit MEP Tips&Tricks.cleaned.pdf

State of the art MEP software for engineers and designers in the mechanical, electrical, and plumbing (MEP) fields is described here: https://www.g2.com/categories/meg. MEP software which enables users to conduct simulations, helping ensure their building systems do not cause any interference with the rest of the building, is known. MEP software which integrates with general-purpose CAD software is known.

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF THE DISCLOSURE

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide an improved building design system which designs prefabricated walls which are pre-configured, off-site, to receive given mechanical, electrical, and plumbing fixtures, and are then easily assembled, on a building site.

According to certain embodiments, pipes or cables which run through a wall are installed on-site e.g. threaded on-site through a tunnel made in the wall in the factory. According to another embodiment, the wall and the pipes and cables which run through it are all made in the factory.

Certain embodiments seek to provide a system, which may be used, say, for modular construction projects e.g. by managers, architects, mechanical, electrical, and plumbing (MEP) engineers etc., for automating the manufacturing process of prefabricated modular building elements (such as, but not limited to, wall panel elements, floor cassette elements, and roof cassette elements). The cassette elements may comprise studs or may comprise Cassette Components on page 4 of this link (https://pryda.com.au/wp-content/uploads/pryda-floor-cassette-manual.pdf) e.g. trusses, beams.

The elements of a cassette may also include MEP components installed within the cassette. The system herein, according to certain embodiments, facilitates the placement and deployment of MEP modules (e.g., draining pipe, water pipe, water tap, boiler, electrical switch) within prefabricated modular building elements.

Certain embodiments seek to provide a system for architectural design, the system comprising: a general library of MEP elements storing metadata for each of a first plurality of MEP elements; and/or, for each of a second plurality of projects, a project-specific library of MEP instances storing metadata for all instances of MEP elements present in an individual project from among the second plurality of projects; wherein the metadata for each instance included in each project-specific library includes an indication of wall/s with which the instance is associated; it is appreciated that a single MEP element may be associated with plural wall instances e.g. a single pipe or cable running through plural walls.

Certain embodiments seek to provide a system, computer program product, or method for automating manufacturing of prefabricated modular building elements, the method including: facilitating placement and deployment of MEP modules within at least one modular building element, typically including: scanning MEP module project records, typically including identifying MPRs (Module Project Records) which are part of the modular building element, as opposed to MPRs which are not part of the modular building element and/or accordingly, generating a cutting command file (CCF) e.g., for a modular building element.

Certain embodiments seek to provide a system, computer program product or method, wherein the scanning and accordingly generating include opening an .MEP file and an empty cutting commands file (CCF); and/or at least once, retrieving a module project record (MPR) and/or testing proximity and/or association of the MPR and each time the MPR tests negative e.g., if no association, retrieving a next MPR; and/or when the MPR tests positive as being associated with/proximate to the modular building element), selecting MPR category; and/or appending a template of cutting orders information to the cutting commands file, to yield a cutting commands file including cutting information.

According to certain embodiments, proximity is a heuristic to discovering which MEP element/s is/are associated with which wall/s. Thus, an MEP element which is closer to wall W than to other walls, may be associated with wall W; wall W may be a candidate to be deemed associated with a given MEP element.

It is appreciated that according to certain embodiments, any determinations made automatically e.g. as described herein, such as the wall/s with which an MEP element is/are associated; and/or the desired orientation and position of an MEP element vis a vis the wall to which the MEP element is associated, may be overridden by a human user. Typically, the human user's view of the project design is indicative of the system's decision e.g. the view of the project includes the MEP element positioned as per the system's determination vis a vis the wall which the system (or user) have determined is associated with the MEP element and/or the user may view explicit written associations between uniquely identified MEP elements and uniquely identified walls, such as a table or matrix or chart.

Certain embodiments seek to provide a system, computer program product or method and also comprising closing the cutting commands file once all MPRs have been retrieved hence MPR scanning is complete, thereby to yield a cutting commands file including all cutting information.

The selection may be declared by a field in the MPR which states the selection.

Certain embodiments seek to provide a system, computer program product or method wherein the selection is determined, including checking the design type or category to determine whether the design type or category can or cannot be handled by type dictation; and/or searching for a prefixed template in a module database each time the design type does not dictate the template; and/or computing a template each time no template exists in the database.

Certain embodiments seek to provide processing circuitry comprising at least one processor and at least one memory, and configured to perform at least one of or any combination of the described operations, or to execute any combination of the described modules.

It is appreciated that factory production of walls may include manufacturing solid wall panels and then cutting the panels or layers therewithin, e.g., cutting holes in the panels, to accommodate MEP elements e.g. as described herein, or all or some walls may be formed a priori with holes e.g., by 3D printing.

The following terms may be construed either in accordance with any definition thereof appearing in the prior art literature or in accordance with the specification, or to include in their respective scopes, the following:
MEP—intended to include infrastructure which provides either mechanical, or electrical or plumbing related functionalities in buildings and houses, such as air-conditioning, electricity, water supply etc.
MEP modules—intended to include components of the MEP related infrastructure, which typically include functional parts such as electrical switches and outlets for providing electricity. Connections between MEP modules may be also considered as modules of a supporting function purpose, such as a water pipe which connects to a tap. The terms MEP modules and MEP elements may be interchanged herewith.
Module library record—intended to include data/listed information, which may be stored in the system's memory e.g. in the system's general dataset, data regarding a module in general, not associated to a specific instance of that module in a specific project e.g., a model X HVAC (heating, ventilation and air-conditioning) device generally, as opposed to three instances of this device deployed in three respective bedrooms in a given apartment in project Y. For example, a single switch panel may be used for turning electricity on or off.
Module project record—intended to include data/listed information which may be stored in the system's memory e.g., in one of the system's project-specific datasets, regarding a specific use or instance of a certain module within a certain project with reference to a module library record for complementing the module description. Thus given, say, a light fixture of type A which is to be deployed both in the bedroom of apartment 5 and in the living room of apartment 7, of a given project, some data regarding these light fixtures may be stored in the fixtures' module project record and other data regarding these light fixtures may be stored in the type-A fixture's module library record in the system memory.
Ghosting—intended to include a visual effect used in 2D or 3D drawing software in which plural files describe plural respective aspects (e.g. structural, architectural, mechanical, electrical, plumbing) of a certain object and, while editing the object, using one file selected from the plural files and representing one specific visual aspect, the information of all or some of the other files is presented for background reference only (typically with no editing allowed, typically upon request e.g. upon selection of certain other files, typically presented as semi-transparent and/or in a different color than the information from the selected file which may be opaque). For example, GIMP software allows a user to conveniently change image opacity while supporting image editing of plural image formats.
Reference Point—intended to include a specific coordinate when describing an object, which some of the geometric aspects of the object, including some its dimensions, are relative to. For example, a triangle defined by its corner points A,B,C might use point A as a reference point, hence B and C may be described using a vector originating at point A and ending at point B (or point C).
Anchor Point—intended to include a specific coordinate used on a base object when positioning another external object with respect to the base object when attaching or fixing itself to it. Typically, attachment is achieved when an anchor point of the base object and a reference point of the external object (at some predefined orientation) overlap. For example, if the object is a 2d-square with the following coordinates (0,0), (0,1), (1,1), (1,0) the reference point may be the square's center i.e. (0.5,0.5). To position such a square at anchor point (10,−3) includes positioning the square's center at the anchor point whereas if the reference point of the module were (0,0), then anchoring point positioning would have positioned (0, 0), the left bottom corner of the 2D square, instead of the center, at the anchor point.
Proximity measurement—intended to include a test for determining nearness (e.g. in meters and/or in pixels) of one object to another object e.g. algebraic distance between Cartesian coordinates of respective objects.
Association measurement—intended to include a test to determine whether or not one object belongs to or is associated with another object or a group of objects. for example, consider a group of N objects which are all of type X (all of the same MEP type e.g.) and another object O1 which may be declared as “associated” with the group because O1 is also of type X whereas if a new object O2 is of Type G then O2 is not associated with the group.

It is appreciated that “objects” may, by way of non-limiting example, include a draining pipe, water pipe, water tap, boiler, electrical switch, wall, floor, door, object, light fixture, oven, HVAC device, living unit/apartment, building.

In some cases, proximity measurement may be used to determine association if physical nearness is an appropriate criterion, otherwise a combination of multiple criteria may be required (e.g., orientation, color, etc.). Orientation typically stipulates the amount of rotation and tilt applied to the object for a given design and may be determined by 2 angles, rotation angle and tilt angle. The anchor point may be the reference point for rotation/tilt and within a design the orientation of object X may include a reference point on object Y and the base rotation and tilt of Y. If for example object Y is already rotated by 30 degrees (and no tilt) then any rotation/tilt of object X may be done relative to Y hence for example, rotation of 60 degrees and 40 degree tilt of X, may in practice be 30+60=90 degrees rotation and 0+40=40 degrees tilt.

Border line or (border shape)—intended to include a computed barrier or limit enveloping the original geometry of a certain object e.g., MEP element. For example, for a physical pipe of diameter D, a virtual pipe of diameter D′>D and centered around the original pipe, constitutes a border line (or shape) which extends beyond the geometry of the original object because the entire object is inside the shape delineated by the border line. If a certain shape S circumscribes a certain object, then shape S is a border shape for that object, for example.

At least the following embodiments are provided herein.

According to some embodiments, a system for architectural design is provided, the system comprising system memory including a general dataset which may include metadata for each of a first plurality of MEP elements and/or metadata characterizing each of at least one type of factory-made walls; and/or, for each of a second plurality of projects, a project-specific dataset which may include a project-specific MEP instances library which may store metadata for all instances of MEP elements (for each “MEP instance”) present in an individual project from among the second plurality of projects and/or a project-specific wall instances library which may store metadata for all instances of walls present in an individual project from among the second plurality of projects, and a hardware processor which provides instructions for factory customization of at least one instance of at least one factory-made wall of at least one type T, to accommodate at least one instance of at least one MEP element E from among the first plurality of MEP elements, wherein the metadata for each individual MEP instance included in each project-specific library includes an indication of the MEP element from among the first plurality, to which the individual MEP instance corresponds and/or wherein the metadata for each individual wall instance included in each project-specific library includes an indication of the type of factory-made walls, to which the individual wall instance corresponds; and/or wherein the project-specific dataset includes an indication of wall instance/s with which each MEP instance is associated.

According to some embodiments, the project-specific dataset includes “module project records” e.g. as described herein, and the general dataset includes “module library records” e.g. as described herein.

It is appreciated that plural instances of a single MEP element and/or plural instances of the same type of factory-made wall may be present in a single project; thus two project-specific walls may both be instances of the same type of factory-made wall or two project-specific MEP elements may both be instances of the same type of MEP element, or example, manufacturer x distributes a model y air conditioner; 3 of these may be deployed in 3 respective rooms in a given apartment in a given building subject of a given project. And/or, a given apartment in a given building subject of a given project may include 2 identical walls, on 2 respective sides of an indoor closet for example. Also, there may be hundreds of apartments rather than a single apartment, in the project.

In contrast, the first plurality of MEP elements whose metadata is stored in the general dataset are all typically distinct from one another, with no duplicates since such duplicates would typically be superfluous.

According to some embodiments, data characterizing walls in the general dataset defines sequences of factory-manufactured layers and metadata may be stored in the general dataset, regarding each of the layers. It is appreciated that a single layer may be included in plural walls. Alternatively, there may be no sequences of layers (or wall level metadata) defined in the general dataset and instead, projects may store, for each project-specific wall instance, a definition of the sequence of layers included in that wall instance. For example, in project A, the wall between the kitchen and master-bedroom might include a first acrylic layer facing onto the kitchen, a thermal layer, a fire-retardant layer, an acoustic layer, and finally another acrylic layer, identical to the first, but facing the master-bedroom. metadata may be stored in the general dataset about each of these layers, some or all of which, in any suitable combination or sequence, may also make up other walls in project A and/or in other projects.

According to some embodiments, for at least one project P, the indication of wall instance/s W1, W2, with which a given MEP instance M, is associated is stored in a record associated with the MEP instance M in the project-specific MEP instances library included in project P's project-specific dataset.

According to some embodiments, for at least one project P, the indication of wall instance/s W1, W2, with which a given MEP instance M, is associated is stored in record/s respectively associated with the wall instance/s W1, W2, in the project-specific wall instances library included in project P's project-specific dataset.

According to some embodiments, the instructions for factory customization of a given type T of factory-made walls for association with an MEP element E from among the first plurality of MEP elements is included in metadata characterizing factory-made walls of type T, in the general dataset.

According to some embodiments, the instructions for factory customization of a given type T of factory-made walls for association with an MEP element E from among the first plurality of MEP elements is included in metadata characterizing MEP element E, in the general dataset.

According to some embodiments, metadata included in at least one dataset comprises at least one link to more detailed metadata which is stored externally of the dataset.

According to some embodiments, the detailed metadata includes instructions for using a machine, such as a cutter, to manufacture a wall layer to accommodate at least one MEP element and wherein the instructions are readable by the machine.

According to some embodiments, the indication of wall instance/s with which each MEP instance is associated, includes an indication of the MEP instance's position vis a vis the wall instance.

According to some embodiments, the indication of wall instance/s with which each MEP instance is associated, includes an indication of a room served by the MEP instance, from among plural rooms defined by the wall instance.

According to some embodiments, the indication of wall instance/s with which each MEP instance is associated is provided by an end-user.

According to some embodiments, the indication of wall instance/s with which each MEP instance is associated is provided by an external system via an API.

According to some embodiments, the indication of wall instance/s with which each MEP instance is associated is derived from a 3d model of a building associated with a given project.

Derivation may occur according to any embodiment described herein. It is appreciated that any system derivation of wall instance/s with which each MEP instance is associated and/or of relative orientations of MEP and wall instances, may be candidates which the system then presents to a human user for approval and/or system-authenticates e.g. using system rules. If a candidate is not approved, by the human expert or system, the system may then present another candidate wall instance with which each MEP instance is associated and/or another candidate relative orientations of MEP and wall instances, which again may or may not be approved, and so forth, e.g. until a system-derived candidate is approved or until a human user overrides.

According to some embodiments, a method for architectural design is provided, the method comprising determining walls with which each of plural MEP elements are respectively associated; and/or Providing manufacturing instructions for factory-production of walls wherein each wall w is configured to accommodate all MEP elements associated with wall w.

According to some embodiments, the method comprises providing visualization of MEP elements typically by providing visualization of a 3D model including architectural elements and MEP elements.

According to some embodiments, determining walls with which each of plural MEP elements are respectively associated uses the visualization.

According to some embodiments, the method comprises providing 3D models of the walls and of the plural MEP elements and wherein the manufacturing instructions e.g. cutting instructions for at least one wall layer, are system-generated, using the 3D models.

According to some embodiments, the visualization comprises toggling between: At least partial transparency of architectural elements and non-transparent display of MEP elements, on the one hand, and At least partial transparency of MEP elements and non-transparent display of architectural elements, on the other hand.

According to some embodiments, a computer program product is provided, comprising a non-transitory tangible computer readable medium having computer readable program code embodied therein, the computer readable program code adapted to be executed to implement a method for architectural design, the method comprising: Determining walls with which each of plural MEP elements are respectively associated; and Providing manufacturing instructions for factory-production of walls wherein each wall w is configured to accommodate all MEP elements associated with wall w.

It is appreciated that any reference herein to, or recitation of, an operation being performed is, e.g. if the operation is performed at least partly in software, intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations and, instead, the remote processor P itself may receive output/s of portion/s of the operation from yet another processor/s P′, may be deployed off-shore relative to P, or “on a cloud”, and so forth.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of at least one conventional personal computer processor, workstation, or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMS, EEPROMs, magnetic or optical or other cards, for storing, and keyboard or mouse for accepting. Modules illustrated and described herein may include any one or combination or plurality of a server, a data processor, a memory/computer storage, a communication interface (wireless (e.g. BLE) or wired (e.g. USB)), a computer program stored in memory/computer storage.

The term “process” as used above is intended to include any type of computation or manipulation or transformation of data represented as physical, e.g., electronic, phenomena which may occur or reside e.g., within registers and/or memories of at least one computer or processor. Use of nouns in singular form is not intended to be limiting; thus the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network or a computer network such as the Internet.

The apparatus of the present invention may include, according to certain embodiments of the invention, machine readable memory containing or otherwise storing a program of instructions, which, when executed by the machine, implements all or any subset of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices, or may be provided to external factors e.g. via a suitable data network. The term “computer” should be broadly construed to cover any kind of electronic device with data processing capabilities, including, by way of non-limiting example, personal computers, servers, embedded cores, computing system, communication devices, processors (e.g., digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g., chips, which may be co-located or remote from one another. Any controller or processor may for example comprise at least one CPU, DSP, FPGA, or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components, and alternatively may be the same structure. A statement that an element or feature may exist is intended to include (a) embodiments in which the element or feature exists; (b) embodiments in which the element or feature does not exist; and (c) embodiments in which the element or feature exist selectably e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface or other system illustrated or described herein. Any suitable computerized data storage e.g., computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein, which may, for example, include all or any subset of an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof and back-end logic interacting therewith. Thus the term user interface or “UI” as used herein includes also the underlying logic which controls the data presented to the user e.g. by the system display, and receives and processes and/or provides to other modules herein, data entered by a user e.g. using her or his workstation/device.

### BRIEF DESCRIPTION OF THE DRAWINGS

Example embodiments are illustrated in the various drawings. Specifically:

FIG. 1A illustrates a simplified case of a single wall design with the design of MEP modules. In this illustration, the wall is dimensioned and positioned, while the MEP design only started.

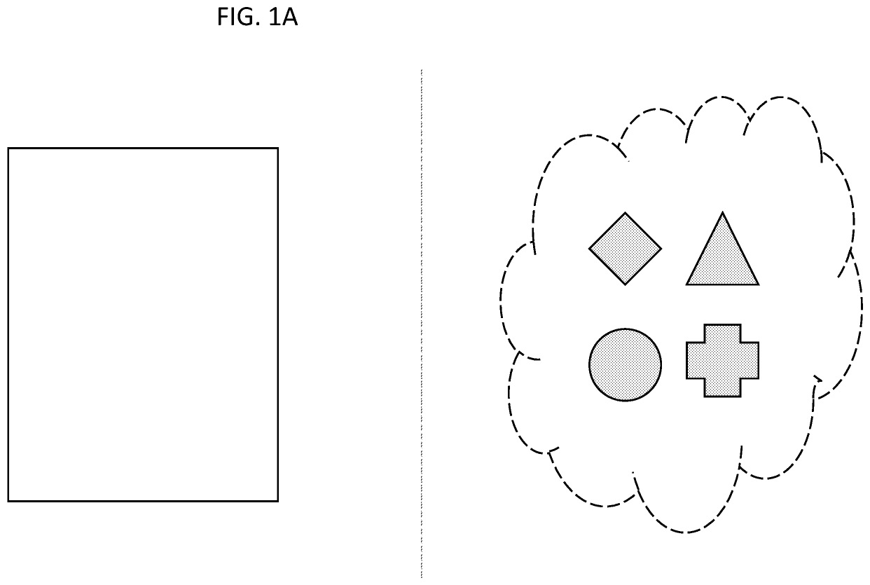

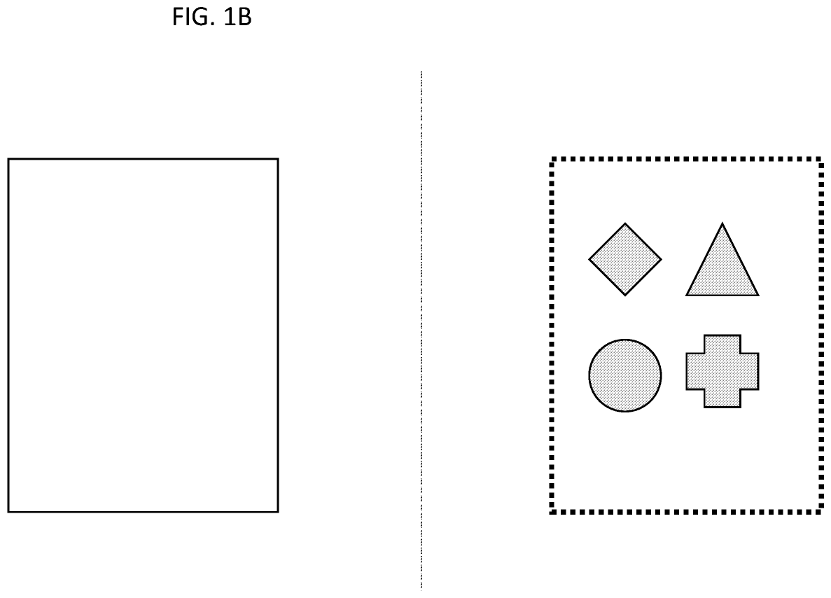

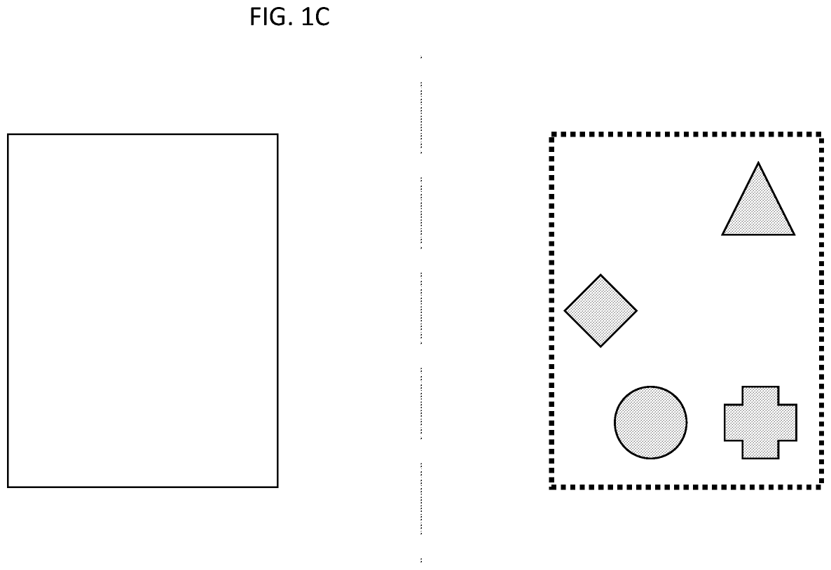

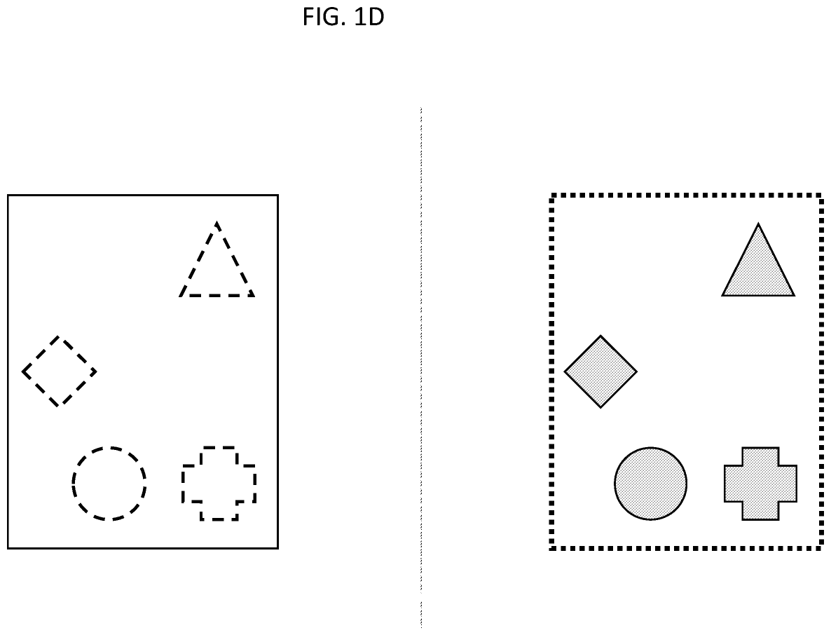

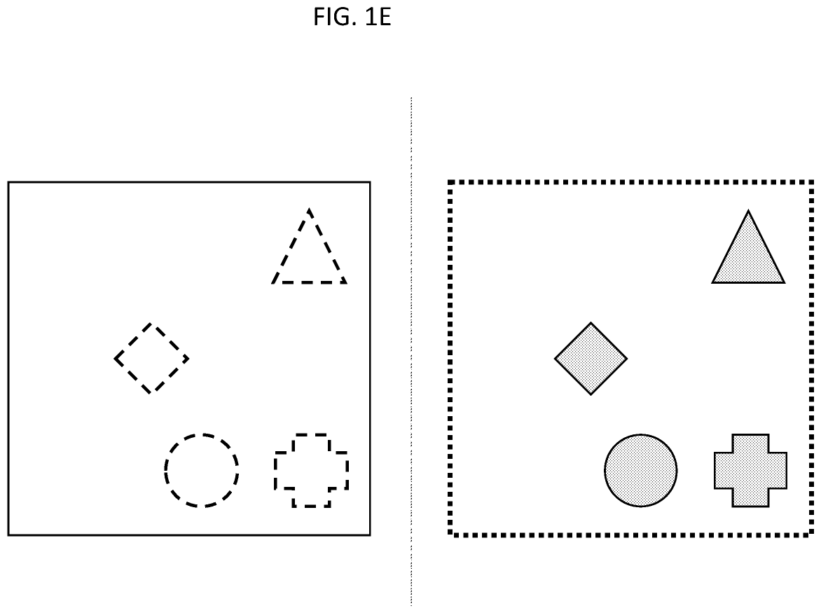

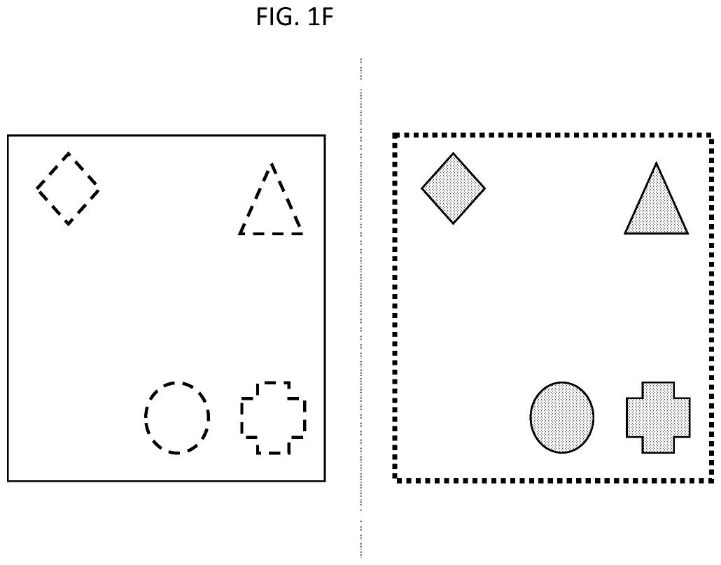

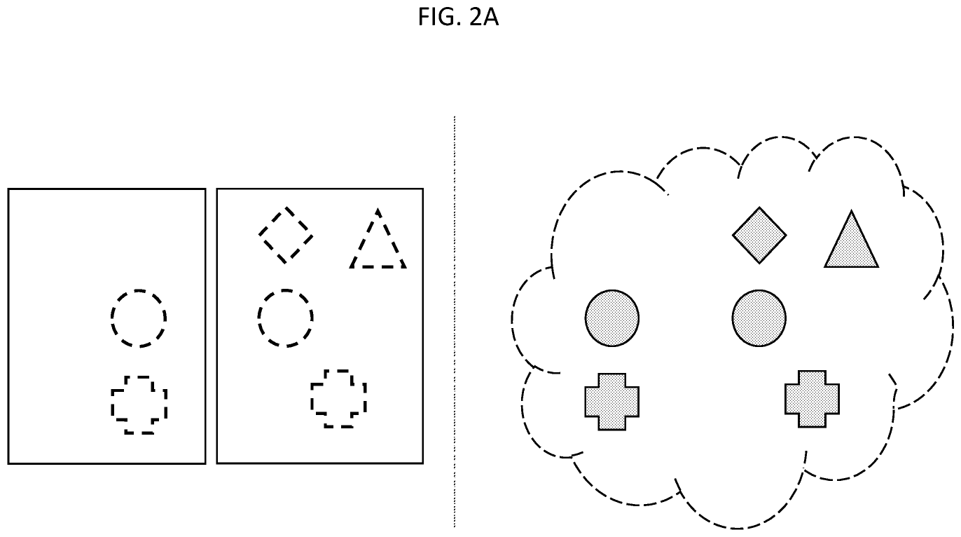

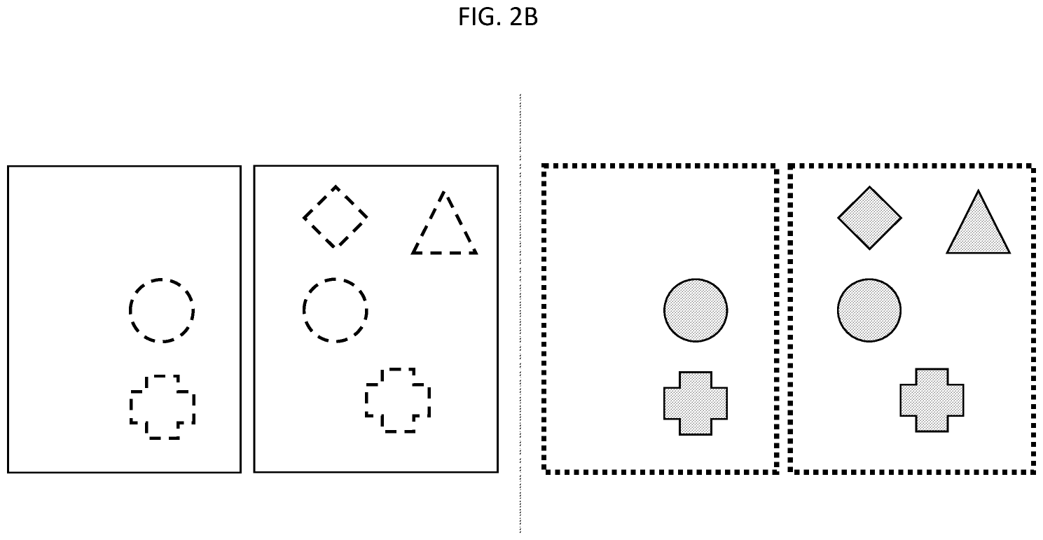

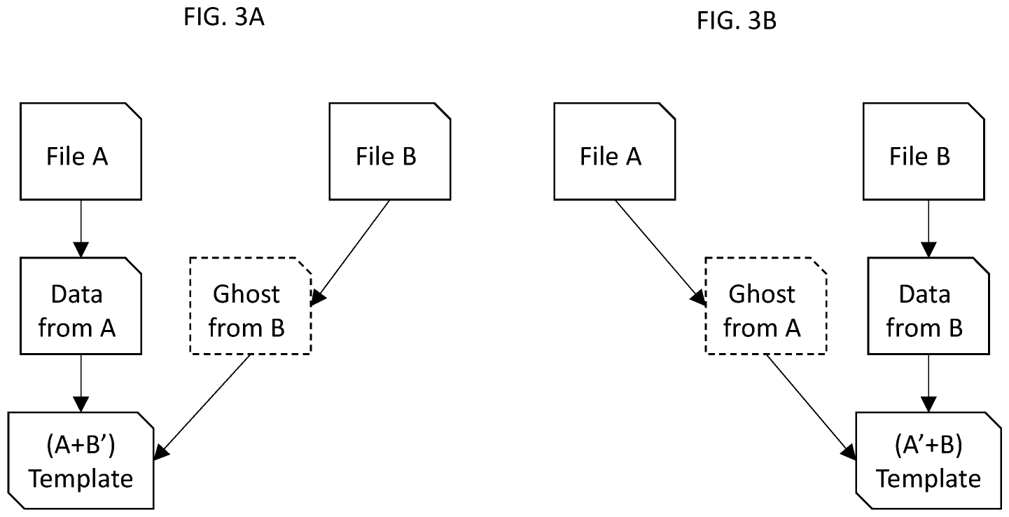

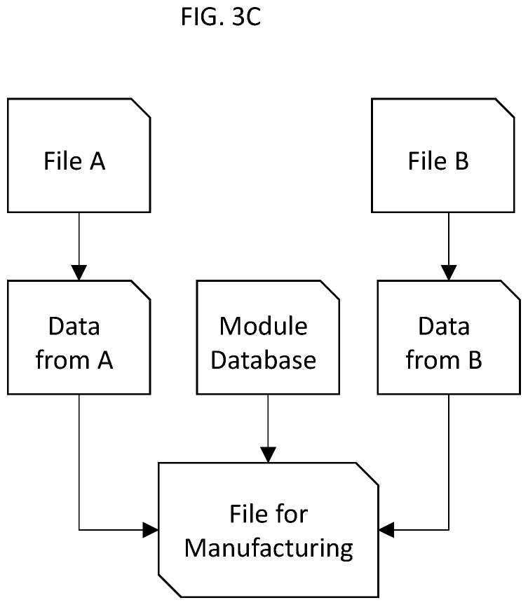

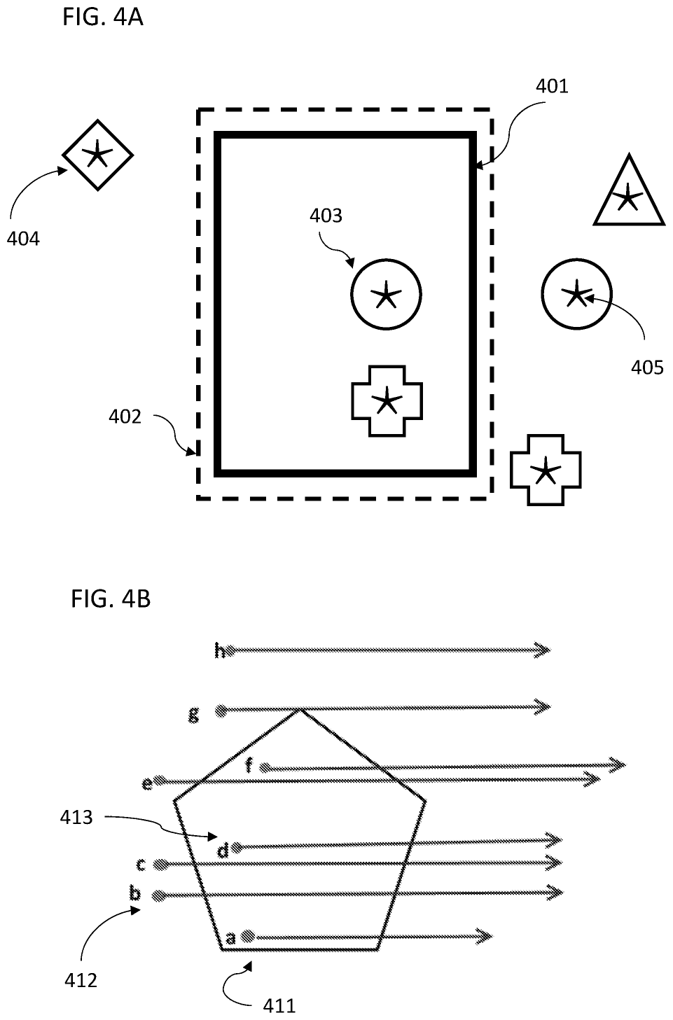

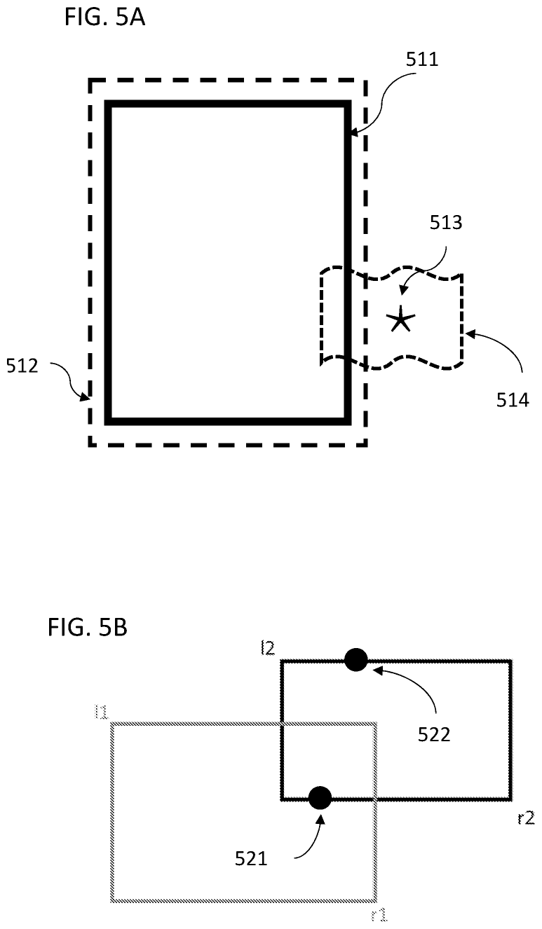

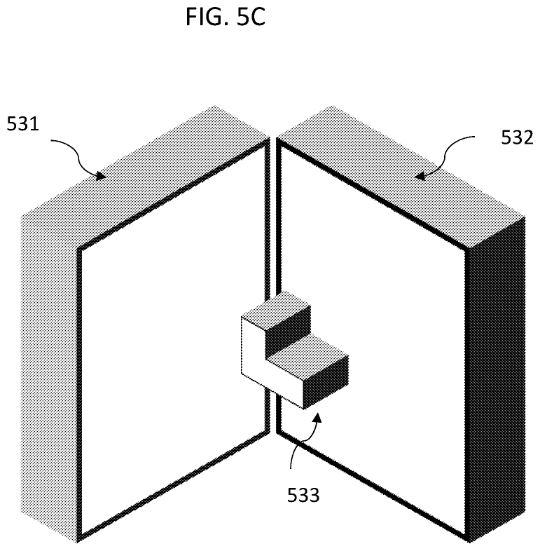

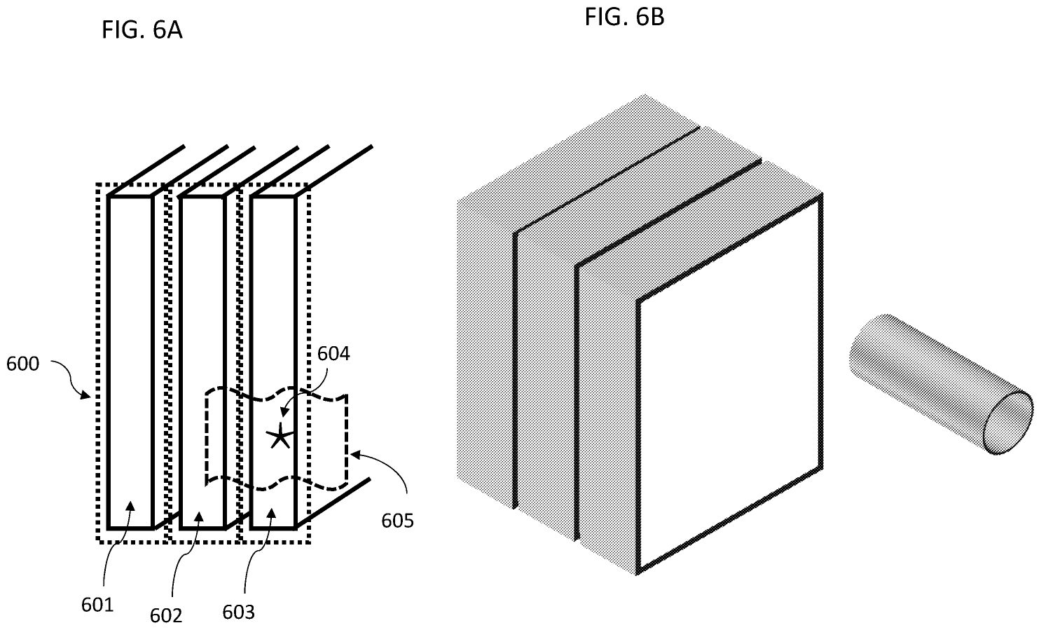

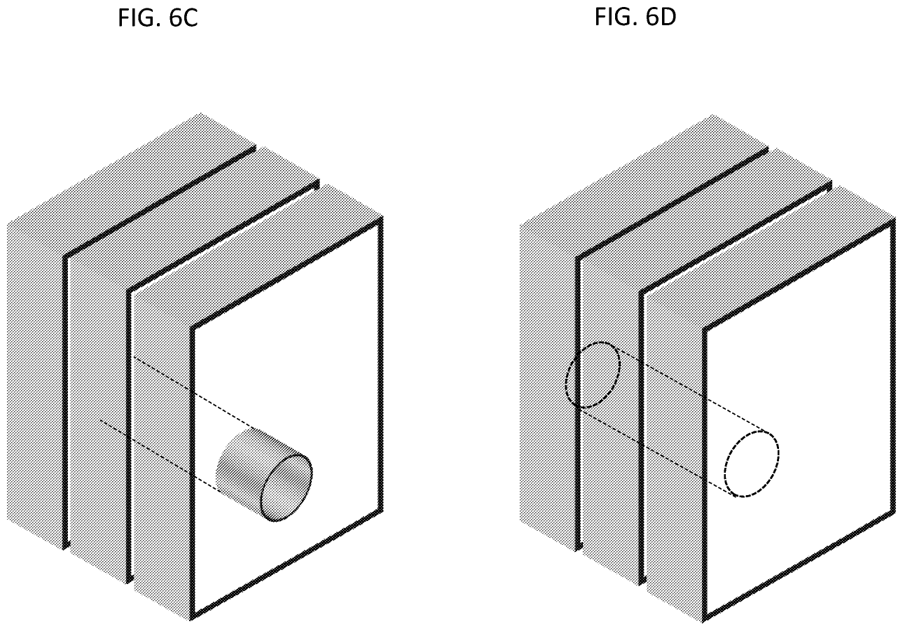

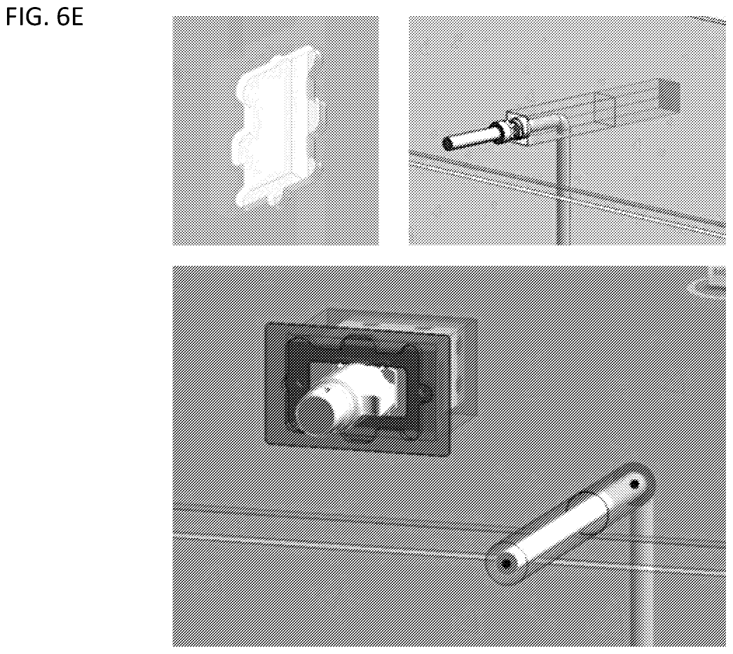

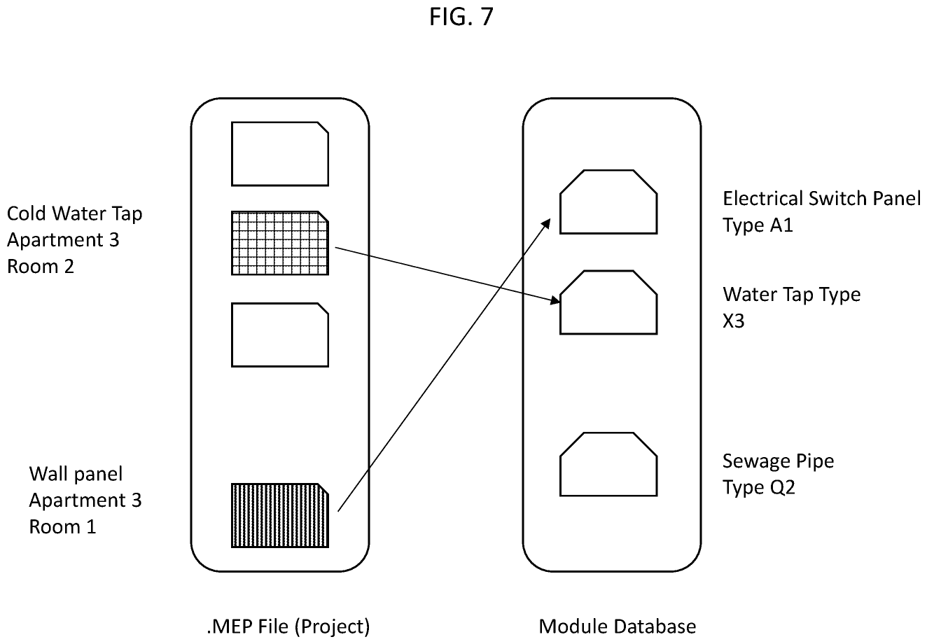

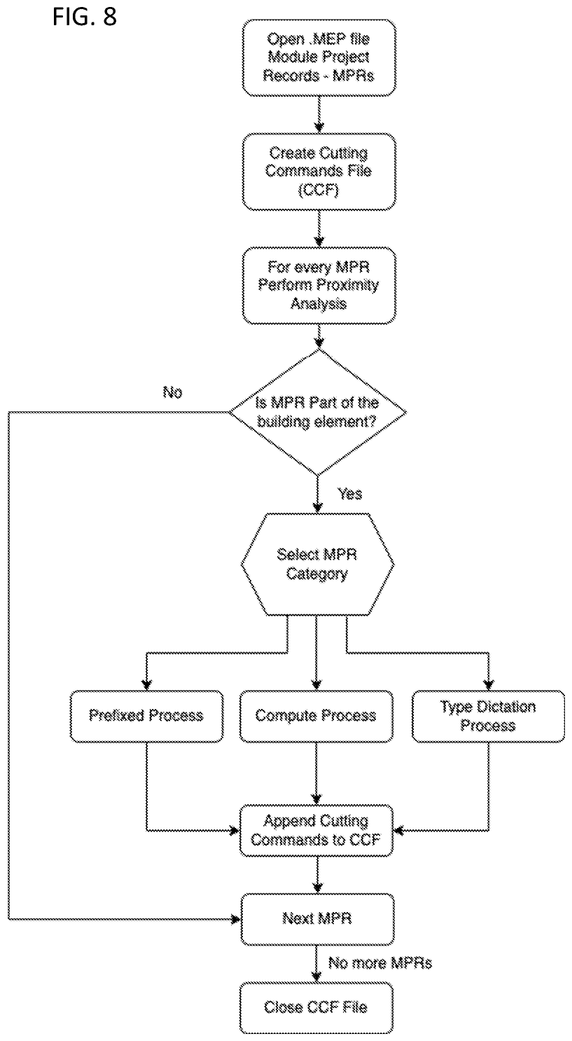

In FIG. 1B, following FIG. 1A, the wall design is “ghosted” on the MEP design template. The term “template” is intended to include a record of listing instructions required for a specific MEP module type assembly preparations including for example aperture dimensions required for hosting/surrounding the MEP module type or a formula or algorithm for deriving the correct aperture dimensions. The record may have different formats dependent on the MEP type.

In FIG. 1C, following FIG. 1B, the MEP modules are placed (showing the “ghosted” wall area).

In FIG. 1D, following FIG. 1C, the MEP modules are “ghosted” on the wall design template.

In FIG. 1E, following FIG. 1D, the wall design is modified, and the “ghosted” modification is presented on the MEP design template.

In FIG. 1F, following FIG. 1E, replacement of MEP modules is “ghosted” on the wall design template.

FIG. 2A presents the design case with multiple walls with associated MEP modules.

FIG. 2B is similar to FIG. 2A, except with a “ghosted” version of the wall design template (more than one wall) on top of the MEP module design.

FIG. 3A shows a file processing flow demonstrating the “ghosting” of File B on File A for creating a workable template denoted A+B′.

FIG. 3B is similar to FIG. 3A, except that the file processing flow demonstrates the “ghosting” File A on File B, creating a workable template denoted A′+B, given that both templates presented in FIGS. 3A and 3B cannot be used for automating a manufacturing process.

FIG. 3C presents a baseline flow-processing the information from both files with aid of an external database and creating the end result file for manufacturing purposes.

FIG. 4A is a 2-dimensional example of proximity measurement for determining relationship and/or association of MEP modules to a building element (a wall in the example).

FIG. 4B illustrates a method for determining if anchor point is enclosed by the reference borderline.

FIG. 5A extends the technique presented in FIG. 4A; the surface lines of the MEP module are retrieved or computed and used for proximity computations. An example of proximity determination is also presented.

FIG. 5B illustrates a method for determining if surface points are enclosed by the reference borderline.

FIG. 5C illustrates that in addition to proximity, additional filtering of association results may be performed by using MEP module orientation.

FIG. 6A illustrates that proximity measurement techniques are extended to the case of multi-layered building elements for determination of layer specific proximity.

FIG. 6B illustrates an example of a multi-layered building element (wall, 3 layers) and a MEP module (cylinder). In this case the MEP module does not impact the wall.

In FIG. 6C, following FIG. 6B, the MEP module penetrates the wall surface and an additional layer.

In FIG. 6D, following FIG. 6C, the MEP module resides within the wall without penetrating the wall surface (internal cut only).

FIG. 6E illustrates examples of MEP related cutting in a wall.

FIG. 7 shows a relationship between module project records and module library records.

FIG. 8 illustrates an MEP module project record scanning and analysis method for generating a cutting command file (CCF) which includes cutting commands which are typically machine readable by a given machine and therefore, are typically provided in a predetermined format e.g. a suitable CNC protocol such as but not limited to protocol/s described in the following link: https://www.thefreelibrary.com/Understanding+common+CNC+protocols.-a020429590

Certain embodiments of the present invention are illustrated in the above drawings; in the block diagrams, arrows between modules may be implemented as APIs and any suitable technology may be used for interconnecting functional components or modules illustrated herein in a suitable sequence or order e.g. via a suitable API/Interface. For example, state-of-the-art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. According to one embodiment, one of the modules may share a secure API with another. Communication between modules may comply with any customized protocol or customized query language, or may comply with any conventional query language or protocol.

Methods and systems included in the scope of the present invention may include any subset or all of the functional blocks shown in the specifically illustrated implementations by way of example, in any suitable order e.g., as shown. Flows may include all or any subset of the illustrated operations, suitably ordered e.g., as shown. Tables herein may include all or any subset of the fields and/or records and/or cells and/or rows and/or columns described.

Computational, functional or logical components described and illustrated herein can be implemented in various forms, for example, as hardware circuits, such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave as described herein with reference to the functional component in question. For example, the component may be distributed over several code sequences, such as but not limited to objects, procedures, functions, routines and programs, and may originate from several computer files which typically operate synergistically.

Each functionality or method herein may be implemented in software (e.g. for execution on suitable processing hardware such as a microprocessor or digital signal processor), firmware, hardware (using any conventional hardware technology such as Integrated Circuit technology), or any combination thereof.

Functionality or operations stipulated as being software-implemented may alternatively be wholly or fully implemented by an equivalent hardware or firmware module, and vice versa. Firmware implementing functionality described herein, if provided, may be held in any suitable memory device, and a suitable processing unit (aka processor) may be configured for executing firmware code. Alternatively, certain embodiments described herein may be implemented partly or exclusively in hardware, in which case all or any subset of the variables, parameters, and computations described herein, may be in hardware.

Any module or functionality described herein may comprise a suitably configured hardware component or circuitry. Alternatively or in addition, modules or functionality described herein may be performed by a general purpose computer, or, more generally, by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC, or DSP, or any suitable combination thereof.

Any hardware component mentioned herein may in fact include either one or more hardware devices e.g., chips, which may be co-located or remote from one another.

Any method described herein is intended to include within the scope of the embodiments of the present invention also any software or computer program performing all or any subset of the method's operations, including a mobile application, platform or operating system e.g., as stored in a medium, as well as combining the computer program with a hardware device to perform all or any subset of the operations of the method.

Data can be stored on one or more tangible or intangible computer readable media stored at one or more different locations, different network nodes, or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance, and energy use; and which is based on any suitable technologies, such as semiconductor, magnetic, optical, paper, and others.

### DETAILED DESCRIPTION OF THE DISCLOSURE

Certain embodiments provide a construction method which may include all or any subset of the following stages, in any suitable order e.g., as follows.
Stage 1 includes “ghosting” in which visualization functionality provides visualization of MEP elements (such as pipes deployed inside a wall) e.g., by providing a transparent or semi-transparent representation of the wall.
Stage 2 determines which wall and which layers, is each MEP element or module associated with e.g. as described below.
Stage 3 determines what to cut and where, when manufacturing the wall, e.g. as described below. Thus typically, the system first determines whether a given MEP module belongs to or penetrates or is associated with a given wall and then, according to the MEP module's type, derives cutting instructions.
Stage 4 comprises manufacturing the wall accordingly.
Stage 5 comprises constructing the house on site, using the walls as manufactured and installing the MEP elements in the stipulated walls and layers.

According to certain embodiments, a system e.g., as provided herein is provided whose method of operation includes all or any subset of the following, suitably ordered e.g., as follows.

In a first step, architects see MEP elements which are at least partly transparent, and architectural elements which are opaque or are not transparent, whereas an MEP engineer sees MEP elements which are opaque or are not transparent, and architectural elements which are at least partly transparent. This typically is possible because the system is configured with a “ghosting” feature which typically allows end-users to toggle, selectably, between presenting MEP elements which are at least partly transparent, and architectural elements which are opaque or are not transparent, on the one hand, and presenting MEP elements which are opaque or are not transparent and architectural elements which are at least partly transparent, on the other hand. End-users may be able to toggle between opaqueness and transparency for any or plural aspects of the building designs e.g., architectural, mechanical, electrical, or plumbing.

In a second step, system functionality creates metadata for each MEP element indicating a wall with which an MEP element is associated e.g., a pipe is associated with wall 3 because the pipe is embedded therewithin, or an electrical light switch is associated with wall 4 because the switch is mounted thereupon.

The functionality may also generate metadata indicating which of the wall's main surfaces an MEP element is associated with e.g., an electrical light switch is associated with wall 4's first side which faces the kitchen, not with the wall's second side which faces the bedroom, because the switch is intended to serve the kitchen. The walls may include plural layers and the functionality may also generate metadata indicating which of the wall's layers an MEP element is associated with, e.g. an electrical light switch may be associated with (may be intended to be mounted on) one of the wall's 2 outward-facing main layers such as a first outward-facing main layer which faces the kitchen, not with the wall's second outward-facing main layer which faces the bedroom, because the switch is intended to serve the kitchen. Or, a certain MEP element is a pipe which is intended to run through the wall's structural layer and not through the wall's thermally insulating layer, nor through the wall's acoustically insulating layer.

It is appreciated that the functionality may utilize user-generated labels, if available, to determine a wall with which an MEP element is associated or may deduce this metadata from the 3D model of the room using any suitable rules, e.g., if the user who defined the 3D model failed to provide such labels. For example, an MEP element may be deemed to be associated with the wall that is closest to that MEP element, in the 3D model.

In a third step, according to certain embodiments, cutting instructions are generated for use in factory production of walls including each layer thereof. Typically, each MEP element has a record in a general library which is accessible to all MEP engineers working on respective construction projects. For example, the general library may have N air-conditioner elements including N different models of air-conditioners. Also, each project has a record for each instance of an MEP element which is included in the 3D model for that project. For example, the general library may have 2 models: the Midea U MAW08VIQWT and the GE PHC08LY and project A may have a record for 3 instances of the Midea (deployed in each of 3 bedrooms) and 2 instances of the GE air-conditioner (deployed in the kitchen and living room respectively).

According to certain embodiments (“pre-fixed process” in FIG. 8 e.g.), for at least one MEP element, typically some, most or all, the general dataset stores knowledge of which layers of wall need to be cut where and how e.g., the general dataset may store an indication that for a given element E such as say a light-switch (and, for at least some embodiments or at last some elements, a given orientation thereof), a single 10 cm×12 cm hole, at location x, y on the wall, is to be cut, via all layers through which the MEP element passes, whereas for another element (e.g. a t-shaped pipe), plural holes, with circular cross-section, should be cut. The indication of which layers the element passes through may be uniform and stored in the general dataset in the record devoted to elements of type E, or may be project-specific, or both (e.g. if there is a project-specific stipulation that element E passes through certain layers of a given wall in a given project-specific dataset, then this stipulation may override contradictory stipulations in general memory, or, conversely, in other embodiments, stipulations in the general dataset may override project-specific stipulations.

For some MEP elements, knowledge of what or how to cut may be included in the actual name of the MEP element (“type dictation process” in FIG. 8). For example, “2-inch pipe” implies that a circular hole with a 2-inch diameter, may be required.

According to certain embodiments (e.g., “compute process” in FIG. 8), for at least one MEP element, typically some, most or all, the general dataset stores knowledge of which layers of wall need to be cut, where and how, which includes an analytical formula presenting the knowledge as a function of certain data. For example, the size of hole to be cut may depend on whether or not the wall includes a thermal layer. For example, a pipe of a certain diameter D which perpendicularly penetrates the wall at a certain location, may include an instruction file which calls for a circular aperture cutting matching the pipe's diameter D. or, in a more complex case, the pipe may comprise a refrigerant pipe (part of a HVAC system) which may require insolation materials wrapped around the pipe which effectively increase the pipe's original diameter. The amount of insolation material is a function of its thermal properties and the original diameter of the pipe hence D′=f(D,R), where D′ is the required aperture diameter, f( ) is a predefined function/formula which computes the required diameter based on the original pipe diameter and R is the thermal resistance of the insulation materials. Or, in a more complicated case, the cuttings may change between layers as some layer materials may require additional spacing, say due to condensation issues.

It is appreciated that in the embodiment of FIG. 8, one of the above processes may be selected, typically upon selection of an MPR (module project record) category.

The general dataset may store a given single orientation for at least some MEP elements, such as light switches and air-conditioners, which may be defined as a default orientation absent any contradictory project-specific orientation, or even as the sole approved orientation which overrides user attempts to define contradictory project-specific orientations. Other MEP elements may not have a single orientation stored for them in the general dataset, e.g., pipes which may have a wide variety of legitimate orientations.

According to certain embodiments, an MEP element's location x, y relative to a wall is derived by the system, from a project-specific 3D model of the wall and MEP element, provided by a human user who may drag-and-drop the MEP element at a certain screen location relative to a screen representation of the wall using any suitable method for mapping pixel distances between an on-screen representation of MEP element and wall, to real life distance between the two e.g. as described here: https://stackoverflow.com/questions/25279390/how-to-change-a-pixel-distance-to-meters and/or by determining relative 3D location of an MEP element vis a vis a wall, if both were defined within a 3D modelling system such as AutoCAD or Revit.

Determining which project-specific wall a project-specific MEP element is associated with, may follow rules. For example, at least some MEP elements may be deemed to be associated with the wall to which they are closest (to the wall from which their distance is smallest). Other rules may take into account orientations of the MEP element and wall; for example, a switch or air-conditioner may be deemed to be associated to the closest wall, but not from among all walls, instead only from among those walls which run parallel to the main plane of the switch or air-conditioner. Metadata characterizing MEP elements in the general dataset may store these rules. It is appreciated that a project-specific MEP element may also be labelled, e.g., by the user who defined the element, as being associated with given walls or with given layers within the walls.

It is appreciated that the metadata per MEP element in the general dataset may include a 3D model of the MEP element which may be available from the element's manufacturer. Also, the metadata characterizing each of at least one type of factory-made walls may be available from manufacturers of these walls. The general dataset may also include data regarding which layers of wall need to be cut, where and how, to allow a given wall to accommodate a given MEP element, which data may be stored as cutting instructions formatted for a given cutting machine, based typically on 3D models of both the MEP element and the layers of the wall.

Determining which layer in a project-specific wall a project-specific MEP element is associated with, may follow rules. For example, a given MEP element may be known, by virtue of metadata on that element stored in the general dataset, to be associated with the outermost layer of a wall. However, a given wall, if internal, typically has two outermost layers because the wall is deployed intermediate 2 (at least) rooms e.g. the kitchen and bedroom. One rule may state that the MEP element is associated with the outermost layer to which the MEP element is closest. Alternatively, or in addition, the MEP element's metadata in the general dataset may define the MEP element's back side, and a rule may state that the MEP element is associated with the outermost layer in back of the MEP element's back side, to which the MEP element is closest. Metadata characterizing MEP elements in the general dataset may store these rules.

It is appreciated that the design, implementation, and installation of mechanical, electrical, and plumbing (MEP) systems is typically a complicated task. Existing dedicated design tools and solutions are not optimally adapted for modular, prefabricated building construction.

In traditional construction methodologies, the working assumption is typically that a basic design plan is sufficient for the installation phase of MEP modules, all of most of which typically takes place on-site. Multiple experts (e.g., electricians, plumbers, etc.) may visit the construction site and utilize the basic plans to determine where and how, and which different MEP modules may be laid out and installed. Decisions regarding the deployment particulars at different stages of the construction projects are often taken in real-time throughout the construction process itself.

In modular construction, the goal is to manufacture and fabricate all the building elements in advance. However, the design tools are mostly inherited from traditional construction deployments which tend to emphasize/focus on the design and planning phase, and not on the manufacturing phase for building elements. While the tools do provide visual insights of the complete design, comprehensive information which may be required for manufacturing and automation thereof, is unavailable. So, while visual design tools are well suited for presenting the design and planning phases, they cannot be used directly for obtaining information which may be required for prefabrication in general, and hence automation of such processes is unavailable.

Conventional placement of and building preparation for MEP modules typically requires intensive manual labor which is prone not only to human errors, but to redundant iterations and the waste of time and materials. The system herein may be configured to process available design data, and to create data for manufacturing structural elements e.g., walls, including openings and apertures which may be useful for receiving MEP modules. This facilitates the complete automation of prefabrication processes which involve MEP modules.

The system herein may be configured to establish a relationship between the building elements and the MEP modules e.g. by determining whether or not a given MEP module has an association or is proximate to a given building element, and may automatically create design files for manufacturing. Such files are typically not available directly from visual design tools and cannot be constructed by merging existing information or appending files, as these tools are not directly intended for modular construction. The relationship between a given element and MEP module may include any geometrical/structural/mechanical relationship for example that both the building element and MEP module are deployed within the same vicinity d<D where D is a parameter

Typically, the system facilitates a streamlined manufacturing process of building elements (e.g., walls, floors, etc.). This is well-suited for modular construction, and, in addition, such a process may be automated, hence manufacturing speed and capacity is increased while reducing end-to-end cost, given that waste and manual labor is heavily reduced. Reliability and quality is also greatly improved.

Design of building elements, such as wall panels, or floor or roof cassettes, is typically performed in two parallel paths. The first path focuses on the structural and architectural aspects of the building element, while the second path focuses on the placement of functional e.g., MEP modules within the building element itself. These functional modules either reside completely in the building element itself (e.g., draining pipes), or may include a portion which is deployed on the building element surface (e.g., electrical switch). These functional modules which may include MEP modules or components are typically associated with building utility categories. For example, a mechanical category may include any module associated with mechanical engineering aspects of the operation including air-conditioning and ventilation modules. An electrical category may include a any module associated with the electricity supply or control, including high power delivery (e.g., boiler), low power delivery (e.g., DC charging). In some cases, alarm control systems and/or telephony and networking modules may be provided. A plumbing category may include any module which is associated with the supply, drainage or control of water and sewage (e.g., water pipes, water taps, toilets, sewage pipes).

The engineering design and placement of MEP modules is typically assisted by dedicated software tools. The structural or architectural designer typically uses a similar tool, e.g. Revit by Autodesk yet with a different purpose and focus. While the MEP designer is focused on a specific infrastructure deployment (e.g., plumbing system) and regards the surrounding walls, floors, and ceilings either as obstacles or housing structures for the designed system, the building architect on the other hand acknowledges that MEP modules may populate the building infrastructure, but the architect's design focus is on the structural and architectural aspects of the building.

This is presented in simplified form, in FIG. 1A. A single wall panel is presented to an architect (left) while a MEP engineer handles the related MEP modules (right) to be placed within a wall cassette (wall cassettes are known, see e.g. https://www.designingbuildings.co.uk/wiki/Cassette). Structural and architectural aspects maybe stored and detailed in one file type (e.g., “.ARC”) while the MEP module aspects may be stored and detailed in another file type (e.g., “.MEP”). Without any file synchronization process, these two files may remain independent, lacking mutual awareness, whereas according to embodiments herein, mutual awareness is achieved, so the MEP design process may accommodate the architectural design, and vice versa.

In FIG. 1B, the MEP engineer is presented with a “ghost” drawing of the designed wall by the architect, and it may be used for reference and aid while placing various MEP modules (e.g., as shown in FIG. 1C). As the engineer continues the MEP design, a “ghost” drawing of the MEP modules and their rough placement is presented to the architect (e.g., as shown in FIG. 1D).

The architect may continue his own design process and modify the building element (e.g., as shown in FIG. 1E). These changes may be reflected by a modified “ghost” drawing presented to the MEP engineer. On the other hand, the MEP designer may continue and modify the MEP components and their placement, and, as seen in FIG. 1F, these changes may be presented to the architect by modifying the “ghost” drawing of the MEP modules.

The above-described illustrations have presented a simplified case, of a single wall and plural MEP modules, yet, as presented in FIG. 2A, the building includes more than one wall (or any other building element) and MEP modules may populate more than one wall (or building element) as well.

From a MEP module design point of view, the modules may create their own network (e.g., functional connectivity) for addressing the specific utility purpose (e.g., delivering electricity), and in a way dismissing or ignoring the wall boundaries. Therefore, in many cases, given a specific MEP module, the clear association to a wall panel or a floor cassette, cannot be easily made merely by inspecting the MEP related plans, yet virtually as seen in FIG. 2B, the “ghosted” wall design implies such boundaries.

It may be assumed that at some point, the design and planning process may be concluded with 2 completed files (e.g., “X.ARC”, “X.MEP” where “X” denotes the project or task name) describing the details of the building element, one file (“X.ARC”) detailing the structural and architectural aspects, while the other file (“X.MEP”) detailing the MEP modules aspects. For traditional building construction projects, this dual path methodology suffices.

Unfortunately, these files together do not provide clear rules or instructions for a complete automated manufacturing process such as encountered in a complete prefabricated modular construction space. Thus, while it is common to use only the structural and architectural file (“X.ARC”) for either manual labor driven deployments, or even for deriving an automation plan of the basic construct of the building element, it is expected that the MEP module file, which is expected to describe roughly where modules should be installed, and other preparations which may be necessary for MEP module installation, may be used for guiding manual labor procedures. This work effort may become even more complicated when the building elements are multi-layered, closed wall panels, or closed floor/roof cassettes.

It is appreciated that merely appending or merging both file types into one file, cannot actually resolve the problem of providing an automation plan for manufacturing e.g., due to the following reason/s. First the “.MEP” file provides mostly the anchor point positioning aspects of the MEP modules. In a typical case, the MEP module may be detailed and complex, yet its presence is abridged to some minimal information as a single coordinate indicating a location in space with no further details to process. Second, there is no clear association between the MEP module and the building element, as each design file type utilizes a ghosted version of the other such that in effect, each designer is focused exclusively on certain design aspects whereas the other aspects are only visible for notification/observation purposes and cannot be edited. Third, the impact of the MEP module placement on the building element is not evident—in most cases, MEP module deployment is not about placing an object in space as it interacts with the different layers of the building object, and in some cases with its exterior parts.

In FIGS. 3A and 3B a file presentation process provided in accordance with certain embodiments, is shown. In FIG. 3A, File A which is used for the architectural and structural detailing information (*.ARC), is used in conjunction with a “ghosted” copy of File B which is used for the MEP module detailing information (*.MEP). The template (e.g., viewable 2D or 3D dynamic graphic representation) is an overlay of the original data retrieved from File A and a static snapshot (“ghosted”) of the data retrieved from File B. The focus of the template in this case is to be used by the architects and designers, e.g., as described above.

In FIG. 3B, the flow is mirrored; File B, used for the MEP module detailing information, is used in conjunction with a “ghosted” copy of File A. The template (viewable 2D/3D dynamic graphic representation) is an overlay of the original data retrieved from File B and a static snapshot (“ghosted”) of the data retrieved from File B. The focus of the template in this case is to be used by the MEP engineers, e.g., as described above.

In FIG. 3C, a different flow, all or any subset of whose operations may be used by the system described herein, is presented, e.g., acknowledging the fact that for manufacturing purposes, “ghosting” file combinations do not provide any useful information for generating specific assembly and production instructions. In FIG. 3C, both file types are processed together and a suitable process (e.g. as described below e.g. with reference to FIG. 8) may be used for assimilation of files utilizing an additional database which stores MEP module specific data records. The assimilation process generates detailed design information which includes all openings, holes, gaps, and apertures, which may be required for all MEP modules. This detailed design may be used for automating the manufacturing process.

The method of operation of the system shown and described herein may overcome the obstacles e.g., as previously discussed, and may maintain several options. FIG. 4A presents a problem to be resolved. A building element 401 (e.g., wall) is surrounded by MEP modules (for example, 403, 404). The MEP module location is determined by an anchor point (405) which typically relates to an MEP module reference point (e.g., center of an opening of a pipe, center of an electrical wall panel, etc.) where the Anchor point is the installation point of an module and wherein the module has a (typically predetermined and/or stored in memory) reference point which is positioned at the anchor point at a given orientation. Although “ghosting” provides some visual representation of MEP module positions relative to the building element, the modules are actually “floating” in space with no specific relationship with a building element. Therefore, the method may, e.g., initially, include associating these MEP modules with the relevant building element to be manufactured.

In FIG. 4A, the building element borderline (401) is expanded by some small preset amount (402) resulting in a reference borderline. The expansion amount may even be zero, however, for pragmatic reasons, it is useful to present some expansion amount (e.g., 2%) for nullifying the probability of missing surface mounted modules (e.g., modules which are deployed on the surface of the building element). Typically, the method shown and described herein examines all MEP modules in File B (*.MEP), and, for each encountered module, its anchor point is used for determining inclusion within the building element. If, for example, an MEP module (405) is examined to be determined if it is associated with the building element (401), then the examination is done with respect to the reference border line (402) and not with respect to the original dimensions of the building element (401). The reference borderline dimensions and shape are a direct expansion of the original geometry of the building element (401).

In FIG. 4B, one possibility for determining inclusion is presented. In its most generic format, the building element may be represented by a closed borderline (411) as a polygon. Typically, any closed curve may eventually be approximated by a polygon of a large enough number of sides. When an anchor point is examined (e.g., point b, 412, or point d, 413) a parallel line-ray is extended from the point itself towards the right (or at some fixed direction at infinity). If the number of intersections with the polygon is even, then the point is not enclosed within the polygon (point b, has 2 intersections each), while if the number of intersections is odd, then the point is enclosed within the polygon (point d has only one intersection).

This specific procedure may be made more efficient if, in advance, a point is checked to reside outside of the rectangle positioned between (Xmin, Ymin) and (Xmax, Ymax), where Xmin is the left-most point on the polygon, Xmax is the right-most point on the polygon, Ymin is the lowest height point on the polygon, and Ymax is the highest height point on the polygon. Only points which reside within the rectangle are tested by examining intersections, due to the fact that if it resides outside of the rectangle, it is surely not encompassed by the polygon. If the building element is a simple rectangle (4-sided right-angled polygon) whose sides are parallel to the X and Y axes, then there is no need to determine intersections in this case.

It is appreciated that for modules which are nearby certain walls, the system may be configured to determine whether these modules belong to or are associated with wall x or wall y. Reference is now made to FIGS. 5A-5C.

In FIG. 5A, a method is presented when the anchor point itself may not be sufficient for determining association or proximity. Instead of using the anchor point itself, the surface points of the MEP module may be used instead, which, e.g., as described below, may be evaluated by the system. At this point there are 2 options to consider. A first option is using the surface points themselves or a sample of those points which actually reside on the MEP module surface. In both cases the MEP module is represented by a complex polyhedron, which, as the number of surface points increases, so does the number of the polyhedron sides and the computation complexity when processing such an object. A second option may be using an enclosing simplified surface such as a rectangular prism or a cylinder or a sphere which tightly encloses, e.g., circumscribes, the MEP module surface. The simplified structure is typically easier to process for proximity and/or association computations to determine association and may provide an excellent compromise between speed and accuracy. The proximity and/or association computations may for example be distance related. For example, in the case of 2 points A, B a Pythagorean based distance between coordinates of A and B may be computed. In the case of a curve C and a point P, then the curve C may be approximated by a set of adjacent points C(i) (i=1 . . . . N). For each of these, a distance measurement d(i) between C(i) and point P may be measured and then, the minimal (say) value of d(i) may be used to quantify the proximity of P to C. In FIG. 5A, the reference surface 512 is used in conjunction with the MEP module surface 514. In this example, that the anchor point itself 513, is shown to reside outside of the reference borderline, hence association or proximity cannot be accurately determined only by it.

In FIG. 5B, an example for determining association using the detailed surface information is presented. The surface of the MEP module (in FIG. 5B this may be a rectangular enclosure representing the module's presence e.g., as previously discussed) may be represented by its residing points. For a particular point on the surface, the test discussed above with reference to FIG. 4B may be used. If no surface points are tested positive, then this may indicate that the MEP module is not associated with the building element. For example, 522 may test negative (outside of the building element), while 523 may test positive, concluding that the MEP module penetrates the building element. The number of points to be tested depends on the surface complexity and on the level of accuracy which may be required. In the case of an enclosed surface which approximates the MEP module presence, the number of points may be further reduced. In the case of rectangular prisms, testing the vertices is sufficient.

In addition to proximity testing, in some marginal cases additional information must be used for determining association. For example, an MEP module orientation may be used for filtering such decisions. In FIG. 5C, two perpendicular walls (531, 532) are tested with an MEP module (533). Although this module is nearby the surfaces of both, if the design information is retrieved from the MEP module database, it will be apparent that the module may have some orientation preference. For example, an electrical switch panel may have a clear orientation preference of being installed parallel to the wall surface, hence even if nearby another perpendicular wall, (corner) it may fail the association test as the switch panel's orientation is positioned in the wrong direction.

In some cases, an MEP module may be associated with plural building elements (e.g., water pipes) and the specific orientation and position of the module and of the building element itself may determine any preparations that may be necessary. Additional information may also be used for reinforcing proximity and/or association decisions, although care should be taken when considering it. For example, in many cases, the MEP module file (*.MEP) may include specific association information (e.g., Module M3 resides within Wall Panel W5). However, in many cases this type of association is either missing or flawed due to human errors and may be irrelevant when a module is associated with more than one building element (e.g., water pipe).

A multi-step process for determining proximity and/or association may take place using a combination of the previous methods. For example, a coarse estimate may be used for a first round of computations, followed by a finer estimate for a second round of computations. For example, an anchor point based estimation may be used for a first round, dismissing any MEP modules which are “too far” from the building element, followed by a finer estimate based on a more accurate surface estimate of the MEP module.

The above examples and the discussions focused on a two-dimensional space. The methods herein may be extended to a three-dimensional space use-case. For example, rectangle shapes may be replaced with rectangular prisms when applicable, etc. The proximity test which is based on a Pythagorean distance computation, may be extended as well, hence instead of computing the distance between (a,b) and (A,B), the 3D equivalent may compute the distance between (a,b,c) and (A,B,C), etc.

In FIG. 6A, proximity and/or association are further expanded for multi-layer building elements. A multi-layer structure may be treated as a single layer structure (600 which may include multiple layers) and whatever test or procedure previously used, may be applied for this structure as a whole. In FIG. 6A, a 3-layer structure is introduced (601, 602 and 603). A reference borderline may be constructed for each layer, and therefore each layer may be checked against the reference point (604) of the MEP module or its surface details (605). This process reveals which layers are affected by the MEP module, if at all, and may be used to determine which openings should be applied in each layer to accommodate the presence of the MEP module for installation.

In FIG. 6B, a 3D view of the 3-layered wall with a cylindrical shaped MEP module is presented. In this case, the MEP module does not impact the wall. In FIG. 6C, the MEP module penetrates the wall—the outmost layer and another layer at least is affected. In FIG. 6D, the MEP module impacts the wall, yet is installed within the construct, without any external presence.

After proximity and/or association computations are finalized, a list of MEP modules which may require specific manufacturing adjustments of the building element (e.g., wall panel) may be generated. This is illustrated in FIG. 6E presenting several real MEP components and their impact and effect on the wall panel construct. For example, some components such as pipes may require a circular opening corresponding to the size of the pipe, while other components may require a complex cutting arrangement for housing the MEP module (e.g., electrical housing of switches or connectors).

Several design paths may be followed, depending on the MEP module category itself. The categories may include, for example, all or any subset of the following. For a prefixed path, typically these include components for which a detailed template for creating an aperture for fitting is available, either in a 2D or 3D format (e.g., if the geometry of the module requires such detailing). For a computed path, typically these include components for which a detailed template for creating an aperture for fitting may need to be computed e.g., based on some available guidelines. The computing may be at least partly based on or depend on the module geometry. However, in some cases additional considerations may be taken into account, such as thermal interaction between the module and the building element, or considerations of aesthetics when (only) a portion of the module is visible. Both examples may impact the aperture geometry (and may change between layers in the case of a multi-layered building element). For a design type dictated path, these are components which the template is derived in a straightforward manner from the module software object type as created by the software design tool used for MEP design. This option is described further below.

Information which may be required for detailing resides in an MEP module database, as indicated by FIG. 3C. An MEP module record may be provided in the module database (which may be deemed the module library record) and/or an explicit MEP module or “instance” of this specific MEP module in a given project P may be part of a design of project P (e.g. stored in a *.MEP file for the project, module project record).

On one hand the module library records contain information such as the detailed geometry and computational guidelines, yet, on the other hand, the module project record may refer to a corresponding object in a module database (holding library records) and to the data representation derived from the design software tool itself (such as object type).

For example, in FIG. 7, the .MEP file lists a module project record representing a cold water tap object as part of the building infrastructure (location noted). The module project record states that the object is actually a “Cold Water Tap Type X3” which is implied by the MEP module database. Typically, further details regarding the geometry of such an object are detailed within the module library record.

In another example, also in FIG. 7, a wall panel module project record is actually an “Electrical Switch Panel Type A1” which is implied by the MEP module database. In this example it is known that a panel may actually contain 1, 2, or 3 switches, hence the actual number of switches of the physical module to be used in the project is listed as a variable to be used by the module project record. As the actual panel size changes according to the number of switches, the module library record may contain the procedure or formula which may be needed to compute the corresponding geometry.

In another example, the implied geometry of a related MEP module aperture may be applied (e.g., as previously discussed) by the simple object type association as indicated by the software tool. This is the case where there is no actual need for retrieving information from the MEP module database, and the object type itself is sufficient for performing the computation which may be required. For example, Revit by Autodesk maintains a “line based” object type which is typically used for pipe plumbing elements, dictating a starting point and an end point which may be included in/be part of the object record. An MEP module which is of this type, dictates a simple hole opening structure which corresponds to the pipe diameter with some margins. This information, e.g., as previously indicated, is derived as a result of the Revit/Autodesk type, and not by the module database.

In multi-layered building elements, the aperture geometry may be conditioned by each layer differently, and it is expected that the template generation may be repeated for each layer according to its own set of restrictions on top of the geometrical considerations of the module.

FIG. 8 shows an example method of operation, which includes all or any subset of the following operations, suitably ordered e.g., as follows:

Operation 810 Open MEP file Module Project Records-MPRs Operation 820 Create Cutting Commands File (CCF)

Operation 830 For every MPR perform proximity analysis

Operation 840 determine is the module subject of the MPR part of the building element e.g. actually embedded in the wall as opposed to merely being associated with the wall.

Operation 850 Select MPR category, then perform, e.g., by predetermined prioritization, operation 860 Prefixed Process, operation 870 Compute Process or operation 880 Type Dictation Process.

Operation 890 Append Cutting Commands to CCF

Operation 894 go to next MPR or, if no more MPRs

(e.g. no more cutting commands to append as all instructions for cutting operations have been utilized] then, in operation 898, Close CCF file.

The flow may for example include all or any subset of the following operations.

At operation 810, the .MEP file is opened and the module project records (MPRs) may be retrieved.

At operation 820, in parallel, a cutting commands file (CCF) is initiated and opened (at this stage does not contain any information).

At operation 830, the next MPR is retrieved. Proximity and/or association of the MPR is tested e.g. using proximity measurement/testing and/or association measurement/testing. If no association is found, the next MPR is retrieved.

At operation 840, if the MPR tested positive (associated with the building element), then at operation 850, the MPR category is selected. The selection process may be declared (a field in the MPR states the selection) or analyzed in a suitable order e.g. in the following order:

At operation 880, first (typically), the design type or category is checked if can be handled by a type dictation process. It is appreciated that MEP module categories may include, all or any subset of the following: Prefixed, Computed or Design Type dictated, e.g. as described herein.

For “design type” categories, the module requirements are defined or dictated by the module's type e.g. “3 inch Pipe” directly implies cutting instructions to “cut circular hole 3 inches in diameter”.

At operation 860, if design type cannot dictate the template, then a prefixed template is searched in the module database.

At operation 870, if no template exists, then the compute process is selected, and a template is computed.

At operation 880, the template (cutting instructions) information is appended to the CCF. At operation 894, an additional or “next” MPR is called for.

At operation 898, when MPR scanning is complete (e.g. when cutting instructions have been derived for all MPR's) the CCF file is closed since the CCF now includes all cutting information.

According to certain embodiments, the system includes a processor which computes or otherwise provides a portion of at least one layer of at least one wall instance which is to be cut out/empty, when manufacturing the wall instance. More typically, the processor computes or obtains from a human or external source all portions of all layers of all wall instances in a given building or project, which are to be cut out/remain empty, when manufacturing the wall instance. The processor's operation and inputs may be characterized by all or any subset of the following.

A 3D model of the MEP element e and of the type t wall instance, may each be stored in memory and may each include a reference location e.g. Reference point or line segment.

For each instance of element e, to be installed in association with the instance of factory-made wall of type t, thereby to define a pair of instances, the relative position and/or orientation of the reference location of element e (which may be, say, an HVAC appliance such as, say “tornado air conditioner 2.75 hp-24805 btu-wifi-turbo-smart-32x sq”), relative to the reference location of the wall of type t, for that pair of instances, is stored in memory.

The instructions for factory customization may include cutting instructions for a machine such as, say a Viscom CNC milling machine, or a 10.6 micron co2 laser or a 1.06 micron fiber laser, which cuts walls or wall layers such as, say corian layers. The cutting instructions may be derived by superimposing element e's 3d structure onto the type t wall's 3d structure, typically after first alignment element e and the type t wall according to the stored relative position and/or orientation of the two, and accordingly, defining instructions for factory customization, including cutting instructions which leave empty (e.g. Cut out) all portions of type t wall's 3d structure which coincide with element e's 3d structure.

If element e comprises a cable or pipe, the system may store a trajectory followed by a main axis of the cable or pipe through the wall of type t, and may store a 2d geometry of a cross-section of the cable or pipe which may include a point location where the main axis intersects the cross-section. It is appreciated that this trajectory may be defined by a human user or may be derived or at least estimated by the system from a representation of the building digitally generated by a human user.

The stored relative position and/or orientation of the pair of instances may be defined by a human user or may be derived or at least estimated by the system from a representation of the building digitally generated by a human user e.g. Using any method shown and described herein. According to certain embodiments, plural candidate positions/orientations may be proposed by the system, e.g. A sequence of such candidates, and each such candidate may be either approved or rejected by the system (by comparison to rules e.g.) Or by a human expert. If a candidate is rejected, another candidate is generated which may also be either approved or rejected, and so on, until an approved candidate position/orientation is identified by the system.

A candidate orientation/s positions may be compared to rules defining, for example, that one end of a pipe's trajectory through a given wall needs to meet an end of the same pipe's (or cable's) trajectory through an intersecting wall or defining, for example, that certain structural portions of a given wall of type t may not be cut out such that placings of a pipe or cable or other element e vis a vis the wall of type t which result in these structural portions being cut out, result in such placings being rejected and other candidate orientation/s positions/trajectories being considered instead.

The stored relative position of the pair of instances, along the axis perpendicular to the wall layers, may be defined by a human user or may be derived or at least estimated by the system based on system rules. For example, there may be layers through which elements e (or certain elements e) must not pass or preferably do not pass. And/or there may be a rule that preferably, element e, or a given surface thereof, should be flush with a given wall layer e.g. Flush with the external wall surface (with the outermost wall layer's out-facing surface).

System rules may define that certain elements e may pass through certain types of wall layers but not other and/or may define a ranking of wall layers such that a given element e should pass, if possible e.g. If there exists a candidate which is not rejected, through a certain layer, and if not, then through some other layer, and so on, e.g. Until layer/s are reached through which element e must not pass.

Ninth, cutting instructions which leave empty (e.g. Cut out) all portions of type t wall's 3D structure which coincide with element e's 3D structure may include instructions to cut around a perimeter of the portions of type t wall's 3D structure which coincide with element e's 3d structure or instructions to place layer material only in portions which differ from and/or are external to, those portions of type t wall's 3d structure which coincide with element e's 3D structure.

Tenth, the processor may derive, from the 3d models of element e and the wall, and from a candidate relative orientation of the wall instance and instance of element e, a set of layers in the wall with which element E intersects and may compare the set with system rules which determine whether an instance of element E is allowed to intersect with all layers in the set; if not, then the candidate relative orientation may be rejected.

Rules may include (by way of non-limiting example) rules governing permissible and/or non-permissible proximity of different MEP elements. For example, rules may stipulate minimal physical distances to be maintained between electrical fixtures and plumbing fixtures. Therefore, if the system, according to embodiments herein, or a user has positioned electrical fixtures and plumbing fixtures, which may be associated with a single wall or with 2 adjacent walls, in a manner which contradicts the rules, thereby to propose candidate position/s or orientation/s for the electrical and plumbing fixtures, then the system may reject the candidate position/s and/or orientation/s of the electrical and/or plumbing MEP elements, once the existing rules have been run on these candidate position/s. rules may be specific to certain types of MEP elements, for example a rule may stipulate that water or sewage pipes need to slope downward.

It is appreciated that embodiments herein, which enable walls to be pre-manufactured to accommodate MEP elements, are far superior to conventional building methods in which the same MEP elements are selected and provided after the walls have been constructed and/or assembled, often resulting in non-aesthetic installation of MEP elements in which cables and/or pipes are visible rather than being within the walls and/or in costly, damaging installation, which invades existing walls to introduce MEP elements, ex post facto, into the wall, and then re-finishes the wall. Another advantage of embodiments herein is that installation of various types of MEP elements e.g., electrical vs. plumbing elements, which may be physically adjacent, may require complex considerations; advance planning according to any embodiment herein enables such considerations to be made at the design stage, within a single system, rather than on-the-spot, on-site installation decisions being made by various types of MEP installation experts such as plumbers or electricians, at the building site, which may limit or impede later installations of other MEP elements, in similar locations in the same building or structure. Within the single system, e.g., as described herein, MEP and/or architectural experts of any discipline may visualize installation ahead of time, using visualization tools provided by the system. Another advantage is that conventional architecture, engineering, and construction software tools, and conventional building information modeling software do not integrate in any way with modern pre-fabrication of walls e.g., layered walls. The system herein provides such integration e.g., by yielding cutting instructions for CNC-driven factory cutters. This may be used to enable mass-production of wall workpieces with CNC-driven customization of the workpieces to enable pre-fabricated workpieces to accommodate MEP elements, by cutting workpieces, in the factory, using cutting instructions generated e.g. as described herein.

It is appreciated that Autodesk Revit® provides a .NET API which may be useful in implementing embodiments herewith. The Autodesk Revit® Software Development Toolkit (SDK) provides .NET code samples any of which may be used herein for implementation, and also provides documentation; both the SDK's .NET code samples and the documentation are hereby incorporated by reference. Any suitable .NET compliant programming language, such as but not limited to C#, VB.NET, F #) may be used to develop a plug-in to implement embodiments shown and described herein.

It is appreciated that terminology such as “mandatory”, “required”, “need” and “must” refer to implementation choices made within the context of a particular implementation or application described herewithin for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g. in software, any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g., by one or more processors. The invention shown and described herein may include (a) using a computerized method to identify a solution to any of the problems or for any of the objectives described herein, the solution optionally including at least one of a decision, an action, a product, a service, or any other information described herein, that impacts, in a positive manner, a problem or objectives described herein; and (b) outputting the solution.

The system may, if desired, be implemented as a network, e.g., web-based system employing software, computers, routers, and telecommunications equipment, as appropriate.

Any suitable deployment may be employed to provide functionalities e.g., software functionalities shown and described herein. For example, a server may store certain applications, for download to clients, which are executed at the client side, the server side serving only as a storehouse. Any or all functionalities e.g., software functionalities shown and described herein, may be deployed in a cloud environment. Clients e.g., mobile communication devices such as smartphones, may be operatively associated with, but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false and to perform y each time x is determined to be true, thereby to yield a processor which performs y at least once, typically on an “if and only if” basis e.g., triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous given the state or condition or data. Alternatively or in addition, an alert may be provided to an appropriate human operator or to an appropriate external system.

Features of the present invention, including operations which are described in the context of separate embodiments, may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly, although not limited to, those described in the Background section or in publications mentioned therein.

Conversely, features of the invention, including operations, which are described for brevity in the context of a single embodiment or in a certain order may be provided separately or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g., as illustrated or described herein.

Devices, apparatus or systems shown coupled in any of the drawings may in fact be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

Any suitable communication may be employed between separate units herein e.g., wired data communication and/or in short-range radio communication with sensors such as cameras e.g. via Wifi, Bluetooth or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node).

Any operation or characteristic described herein may be performed by another actor outside the scope of the patent application and the description is intended to include any apparatus whether hardware, firmware, or software which is configured to perform, enable, or facilitate that operation, or to enable, facilitate, or provide that characteristic.

The terms processor or controller or module or logic, as used herein, are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry, including any such computer microprocessor/s as well as in firmware or in hardware or any combination thereof.

It is appreciated that elements illustrated in more than one drawing, and/or elements in the written description may still be combined into a single embodiment, except if otherwise specifically clarified herewith. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g., operation described herein, may have all characteristics and attributes described or illustrated herein, or, according to other embodiments, may have any subset of the characteristics or attributes described herein.

1. A system for architectural design, the system comprising:
system memory including
a general dataset including
metadata for each of a first plurality of MEP elements;
metadata characterizing each of at least one type of factory-made walls; and
for each of a second plurality of projects, a project-specific dataset including:
a project-specific MEP instances library storing metadata for the first plurality of MEP elements for each individual MEP instance present in an individual project from among said second plurality of projects;
a project-specific wall instances library storing metadata for all instances of walls present in an individual project from among said second plurality of projects, and
a hardware processor which provides instructions for factory customization of at least one instance of at least one factory-made wall of at least one type, to accommodate at least one instance of at least one MEP element from among the first plurality of MEP elements,
wherein the metadata for each individual MEP instance included in each project-specific library includes an indication of the MEP element from among said first plurality, to which the individual MEP instance corresponds;
wherein the metadata for each individual wall instance included in each project-specific library includes an indication of the type of factory-made walls, to which the individual wall instance corresponds; and
wherein the project-specific dataset includes an indication of wall instances with which each MEP instance is associated;
wherein the instructions for factory customization comprise cutting instructions for at least one wall layer, which are system-generated, using 3D models of the walls and of the plural MEP elements.

2. The system of claim 1, wherein, for at least one project, said indication of wall instances with which a given MEP instance, is associated is stored in a record associated with said MEP instance in the project-specific MEP instances library included in the at least one project's project-specific dataset.

3. The system of claim 1, wherein, for the at least one project, said indication of wall instances with which the given MEP instance, is associated is stored in records respectively associated with said wall instances in the project-specific wall instances library included in the at least one project's project-specific dataset.

4. The system of claim 1, wherein the instructions for factory customization of the given type of factory-made walls for association with the MEP element from among the first plurality of MEP elements is included in metadata characterizing the factory-made walls of the given type, in said general dataset.

5. The system of claim 1, wherein the instructions for factory customization of the given type of factory-made walls for association with the MEP element from among the first plurality of MEP elements is included in metadata characterizing the MEP element, in said general dataset.

6. The system of claim 1, wherein metadata included in at least one dataset comprises at least one link to more detailed metadata which is stored externally of the dataset.

7. The system of claim 6, wherein the more detailed metadata includes instructions for using a machine, such as a cutter, to manufacture a wall layer to accommodate at least one MEP element and wherein the instructions are readable by said machine.

8. The system of claim 1, wherein the indication of wall instances with which each MEP instance is associated, includes an indication of the MEP instance's position vis a vis the wall instance.

9. The system of claim 1, wherein the indication of wall instances with which each MEP instance is associated, includes an indication of a room served by the MEP instance, from among plural rooms defined by said wall instance.

10. The system of claim 1, wherein the indication of wall instances with which each MEP instance is associated is provided by an end-user.

11. The system of claim 1, wherein the indication of wall instances with which each MEP instance is associated is provided by an external system via an API.

12. The system of claim 1, wherein the indication of wall instances with which each MEP instance is associated is derived from a 3D model of a building associated with a given project.

13. A method for architectural design, the method comprising:
providing system memory including a general dataset including
metadata for each of a first plurality of MEP elements;
metadata characterizing each of at least one type of factory-made walls; and
providing, for each of a second plurality of projects, a project-specific dataset including:
a project-specific MEP instances library storing metadata for all instances of MEP elements for each MEP instance present in an individual project from among said second plurality of projects;
a project-specific wall instances library storing metadata for all instances of walls present in an individual project from among said second plurality of projects, and
providing a hardware processor which provides instructions for factory customization of at least one instance of at least one factory-made wall of at least one type, to accommodate at least one instance of at least one MEP element from among the first plurality of MEP elements,
wherein the metadata for each individual MEP instance included in each project-specific library includes an indication of the MEP element from among said first plurality, to which the individual MEP instance corresponds;
wherein the metadata for each individual wall instance included in each project-specific library includes an indication of the type of factory-made walls, to which the individual wall instance corresponds; and
wherein the project-specific dataset includes an indication of wall instances with which each MEP instance is associated, and
wherein the instructions for factory customization comprise cutting instructions for at least one wall layer, which are system-generated, using 3D models of the walls and of the plural MEP elements.

14. The method of claim 13, further comprising providing visualization of MEP elements by providing visualization of a 3D model including architectural elements and MEP elements.

15. The method of claim 14, wherein said determining uses said visualization.

16. The method of claim 13, wherein said cutting instructions are used to pre-manufacture at least one factory-made wall of said at least one type, to accommodate said at least one instance of said at least one MEP element, and wherein said wall as pre-manufactured is assembled, on a building site, including threading pipes or cables which run though the wall on-site or wherein the wall and the pipes and cables which run through it are all made in the factory.

17. The method of claim 14, wherein said visualization comprises toggling between:
at least partial transparency of architectural elements and non-transparent display of MEP elements, on the one hand, and
at least partial transparency of MEP elements and non-transparent display of architectural elements, on the other hand.

18. A computer program product, comprising a non-transitory tangible computer readable medium having computer readable program code embodied therein, said computer readable program code adapted to be executed to implement a method for architectural design, the method comprising:
providing system memory including a general dataset including
metadata for each of a first plurality of MEP elements;
metadata characterizing each of at least one type of factory-made walls; and
providing, for each of a second plurality of projects, a project-specific dataset including:
a project-specific MEP instances library storing metadata for all instances of MEP elements for each MEP instance present in an individual project from among said second plurality of projects;
a project-specific wall instances library storing metadata for all instances of walls present in an individual project from among said second plurality of projects, and
providing a hardware processor which provides instructions for factory customization of at least one instance of at least one factory-made wall of at least one type, to accommodate at least one instance of at least one MEP element from among the first plurality of MEP elements,
wherein the metadata for each individual MEP instance included in each project-specific library includes an indication of the MEP element from among said first plurality, to which the individual MEP instance corresponds;
wherein the metadata for each individual wall instance included in each project-specific library includes an indication of the type of factory-made walls, to which the individual wall instance corresponds; and
wherein the project-specific dataset includes an indication of wall instances with which each MEP instance is associated, and
wherein the instructions for factory customization comprise cutting instructions for at least one wall layer, which are system-generated, using 3D models of the walls and of the plural MEP elements.
